(19) United States
(12) Patent Application Publication
(10) Pub. No.: US 2023/0017839 A1
(43) Pub. Date: Jan. 19, 2023

(54) RISK ANALYSIS RESULT DISPLAY APPARATUS, METHOD, AND COMPUTER READABLE MEDIA

(71) Applicant: NEC Corporation, Minato-ku, Tokyo (JP)

(72) Inventors: Ryo Mizushima, Tokyo (JP); Hirofumi Ueda, Tokyo (JP); Tomohiko Yagyu, Tokyo (JP)

(73) Assignee: NEC Corporation, Minato-ku, Tokyo (JP)

(21) Appl. No.: 17/785,492

(22) PCT Filed: Dec. 25, 2019
(86) PCT No.: PCT/JP2019/051033

§ 371 Date: Jun. 15, 2022

(51) Int. Cl. G06F 21/57; G06F 21/55

(52) U.S. Cl. CPC G06F 21/577; G06F 21/552; G06F 2221/034

(57) ABSTRACT

A risk analysis result display apparatus, a risk analysis result display method, and a computer readable medium capable of enabling a user to recognize changes in risk in a system are provided. A risk analysis result (13) is a risk analysis result obtained by assessing a risk to a system to be analyzed in a first assessment period. A risk analysis result (14) is a risk analysis result obtained by assessing the risk to the system to be analyzed in a second assessment period different from the first assessment period. Comparison means (11) compares the risk analysis result (13) with the risk analysis result (14), and extracts a difference between the risk analysis result (13) and the risk analysis result (14). Output means (12) displays the difference extracted by the comparison means (11) for a user.

### TECHNICAL FIELD

The present invention relates to a risk analysis result display apparatus, a method, and a computer readable medium.

### BACKGROUND ART

In recent years, threats of cyber-attacks have not been limited to the fields of ICT (Information and Communication Technology), and damages have also been occurring in the fields of control systems and IoT (Internet of Things). In the case of control systems, in particular, there have been cases where the operation of a critical infrastructure has been jeopardized, such as a case where a power system or a factory is shut down. To cope with such threats of cyber-attacks, it is important to clarify security risks present in a system, implement countermeasures thereagainst, and thereby reduce the risks.

In regard to the above-described matters, the Security Center of Information-technology Promotion Agency, Japan, has published a security risk analysis guide for control systems (Non-patent Literature 1). In Non-patent Literature 1, two different methods for analyzing a risk in a detailed manner, i.e., a method for analyzing a risk from the viewpoint of a precise assessment for each system asset and a method for analyzing a risk from the viewpoint of an assessment of an actual attack scenario from an attacker's point of view, are explained. One of the above methods is an asset-based risk analysis, and the other is a business impact-based risk analysis.

In the case of the asset-based risk analysis, a risk is assessed, for each of assets constituting a system to be protected, by using its importance (its value), a possibility of the occurrence of a conceivable threat, and a vulnerability to the threat as three assessment indices. The business impact-based risk analysis is an analysis in which an attack scenario and an attack tree are used. In the case of the business impact-based risk analysis, a risk is assessed, for a business or a service implemented by a system, by using a business damage and its level, a possibility of the occurrence of an attack tree that causes business damage, and a vulnerability to the attack as three assessment indices. Either just the asset-based risk analysis by itself or the business impact-based risk analysis by itself can provide an effective assessment result. However, they also function in a manner complementary to each other, so in some cases, these two different analyses are performed for one control system. A user works out countermeasures for protecting the security of the system based on the result of the above-described asset-based risk analysis and the result of the business impact-based risk analysis.

As a related technology, Patent Literature 1 discloses a vulnerability analysis apparatus that analyzes a vulnerability(ies) in a computer system. The vulnerability analysis apparatus disclosed in Patent Literature 1 identifies a security vulnerability(ies) present in a certain apparatus, and specifies the number of attack patterns against the identified security vulnerability(ies). The vulnerability analysis apparatus specifies display information indicating the security vulnerability according to the number of attack patterns. For example, the larger the number of attack patterns is, the larger size the display information is displayed in, or the closer the display color of the display information is made to a predetermined color (e.g., red).

### CITATION LIST

### Patent Literature

Patent Literature 1: Japanese Unexamined Patent Application Publication No. 2014-130502

### Non Patent Literature

Non-patent Literature 1: “Security Risk Assessment Guide for Industrial Control Systems, Second Edition”, Security Center of Information-technology Promotion Agency, Japan, https://www.ipa.go.jp/security/controlsystem/riskanalysis.html, October 2018

### SUMMARY OF INVENTION

### Technical Problem

In Patent Literature 1, for example, information about a vulnerability for which there are a large number of attack patterns is displayed in a large size. Alternatively, information about a vulnerability for which there are a large number of attack patterns is displayed in red. In general, a vulnerability for which there are a large number of attack patterns is considered to be a vulnerability for which the necessity for security measures is high. By referring to the display information that is displayed according to the number of attack patterns, a user can determine against which vulnerability countermeasures should be preferentially taken.

Note that vulnerabilities are newly discovered day by day. Therefore, systems are compromised more and more over time, so the probability that the systems are attacked increases. By related technologies, such as the one disclosed in Patent Literature 1, it is possible to visualize which asset(s) in the system is at risk. However, in the related technologies, there is a problem that, in the case where, for example, security risks are analyzed at regular intervals, it is difficult to recognize changes in risk, such as which asset(s) in the system a vulnerability(ies) has been occurring.

In view of the above-described circumstances, an object of the present disclosure is to provide a risk analysis result display apparatus, a risk analysis result display method, and a computer readable medium capable of enabling a user to recognize changes in risk in a system.

### Solution to Problem

In order to achieve the above-described object, the present disclosure provides a risk analysis result display apparatus including: comparison means for comparing a risk analysis result obtained by assessing a risk to a system to be analyzed in a first assessment period with a risk analysis result obtained by assessing the risk to the system to be analyzed in a second assessment period different from the first assessment period, and extracting a difference between the risk analysis result obtained in the first assessment period and the risk analysis result obtained in the second assessment period; and output means for displaying the extracted difference for a user.

Further, the present disclosure provides a risk analysis result display apparatus including: comparing a risk analysis result obtained by assessing a risk to a system to be analyzed in a first assessment period with a risk analysis result obtained by assessing the risk to the system to be analyzed in a second assessment period different from the first assessment period; extracting a difference between the risk analysis result obtained in the first assessment period and the risk analysis result obtained in the second assessment period based on a result of the comparison; and displaying the extracted difference for a user.

Further, the present disclosure provides a non-transitory computer readable medium storing a program for causing a computer to perform a process of: comparing a risk analysis result obtained by assessing a risk to a system to be analyzed in a first assessment period with a risk analysis result obtained by assessing the risk to the system to be analyzed in a second assessment period different from the first assessment period; extracting a difference between the risk analysis result obtained in the first assessment period and the risk analysis result obtained in the second assessment period based on a result of the comparison; and displaying the extracted difference for a user.

### Advantageous Effects of Invention

The risk analysis result display apparatus, the risk analysis result display method, and the computer readable medium according to the present disclosure are capable of enabling a user to recognize changes in risk in a system.

### BRIEF DESCRIPTION OF DRAWINGS

FIG. 1 is a block diagram schematically showing a risk analysis result display apparatus according to the present disclosure;

FIG. 2 is a block diagram showing a specific example of a risk analysis result display apparatus according to a first example embodiment of the present disclosure;

FIG. 3 is a table showing a result of a comparison between asset-based risk analyses;

FIG. 4A shows an attack tree assessed in a last business impact-based risk analysis result;

FIG. 4B shows an attack tree assessed by a current business impact-based risk analysis result;

FIG. 5 is a table showing a result of a comparison of vulnerability information;

FIG. 6 shows an example of a displayed comparison result;

FIG. 7A shows another example of a display in a risk analysis result display apparatus;

FIG. 7B shows another example of a display in a risk analysis result display apparatus;

FIG. 8A shows a yet another example of a display in a risk analysis result display apparatus;

FIG. 8B shows a yet another example of a display in a risk analysis result display apparatus;

FIG. 9A shows a yet another example of a display in a risk analysis result display apparatus;

FIG. 9B shows a yet another example of a display in a risk analysis result display apparatus;

FIG. 10A shows a yet another example of a display in a risk analysis result display apparatus;

FIG. 10B shows a yet another example of a display in a risk analysis result display apparatus;

FIG. 11 shows a yet another example of a display in a risk analysis result display apparatus;

FIG. 12 is a flowchart showing an operation procedure performed by a risk analysis result display apparatus;

FIG. 13 shows an example of a display in a risk analysis result display apparatus according to a second example embodiment of the present disclosure;

FIG. 14A shows an example of a display in a risk analysis result display apparatus according to a third example embodiment of the present disclosure;

FIG. 14B shows an example of a display in a risk analysis result display apparatus according to the third example embodiment of the present disclosure;

FIG. 15 is a block diagram showing a risk analysis result display apparatus according to a fourth example embodiment of the present disclosure;

FIG. 16 shows a result of a last risk analysis;

FIG. 17 shows a specific example of a countermeasure result stored in a countermeasure result DB;

FIG. 18 shows an example of a displayed analysis result in the fourth example embodiment;

FIG. 19A shows another example of a displayed analysis result in the fourth example embodiment;

FIG. 19B shows another example of a displayed analysis result in the fourth example embodiment; and

FIG. 20 shows an example of a configuration of a computer apparatus.

### DESCRIPTION OF EMBODIMENTS

### Outline of Example Embodiment

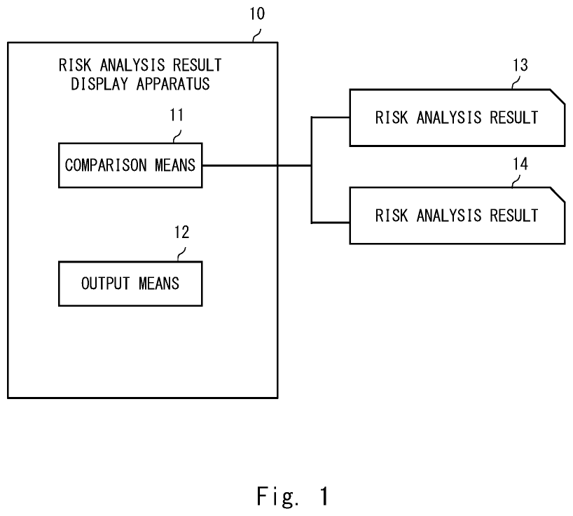

Prior to giving a description of an example embodiment according to the present disclosure, an outline of the present disclosure will be described. FIG. 1 schematically shows a security risk analysis support apparatus according to the present disclosure. The risk analysis result display apparatus 10 includes comparison means 11 and output means 12.

A risk analysis result 13 is a risk analysis result obtained by assessing a risk to a system to be analyzed in a first assessment period. A risk analysis result 14 is a risk analysis result obtained by assessing the risk to the system to be analyzed in a second assessment period different from the first assessment period. The comparison means 11 compares the risk analysis results 13 and 14, and extracts a difference between them. The output means 12 displays the difference extracted by the comparison means 11 for a user.

In the present disclosure, the output means 12 displays, for a user, a difference between risk analysis results that are obtained by assessing a risk in two assessment periods. By doing so, the user can easily recognize how the risk analysis result has changed between the first and second assessment periods, and therefore can recognize changes in the risk in the system.

### First Example Embodiment

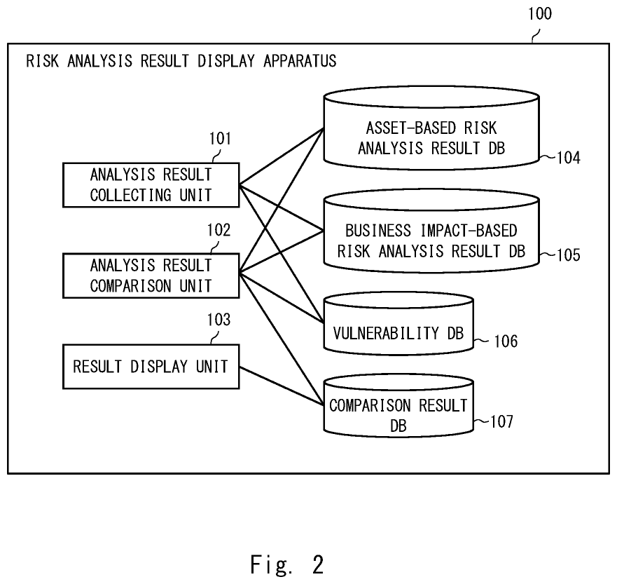

A first example embodiment according to the present disclosure will be described hereinafter in detail. FIG. 2 shows a risk analysis result display apparatus 100 according to the first example embodiment of the present disclosure. The risk analysis result display apparatus 100 includes an analysis result collecting unit 101, an analysis result comparison unit 102, a result display unit 103, an asset-based risk analysis result database (DB: database) 104, a business impact-based risk analysis result DB 105, a vulnerability DB 106, and a comparison result DB 107.

Note that the asset-based risk analysis result DB 104, the business impact-based risk analysis result DB 105, the vulnerability DB 106, and the comparison result DB 107 do not necessarily have to be parts of the risk analysis result display apparatus 100 as long as they can be accessed from the risk analysis result display apparatus 100. For example, at least a part of these databases may be located in a cloud, and the risk analysis result display apparatus 100 may access the database located in the cloud through a network. Further, in these databases, data is stored in a corresponding DB, for example, in the structure of a table or a graph.

The analysis result collecting unit 101 collects risk analysis results for a system to be analyzed. The analysis result collecting unit 101 collects, for example, results of two different risk analyses using analysis methods different from each other. The risk analysis results include a result of a business impact-based risk analysis for the system to be analyzed (also referred to as a business impact-based risk analysis result) and a result of an asset-based risk analysis for the same system (also referred to as an asset-based risk analysis result).

The business impact-based risk analysis result indicates a result of an assessment of a risk that arises when an attack is made along an attack path from an entry point included in the system to be analyzed to an attack target. The attack path includes at least one attack step including an attack source (i.e., an entity or the like which makes an attack), an attack destination (i.e., an entity or the like on which the attack is made), and an attack method. The business impact-based risk analysis result includes an attack step(s) that is used when an attack is made along the attack path, and an assessment index obtained by assessing a risk to the entire attack path. The assessment index includes a threat level, a vulnerability level, a business risk level, and a risk value. Each of the threat Level, the vulnerability level, and the business risk level is assessed, for example, in three levels (i.e., classified into three levels). Each of the risk values (the risk assessment values) for each of attack steps and for the entire attack path is assessed, for example, in five levels (i.e., classified into five levels) according to the combination of the threat level, the vulnerability level, and the business risk level.

Meanwhile, the asset-based risk analysis result indicates a result of an assessment of a risk for an asset(s) constituting the system to be analyzed. The asset-based risk analysis result includes an assessment index obtained by assessing a risk that arises when an attack is made on the asset by at least one conceivable attack method. The assessment index includes a threat level, a vulnerability level, a business risk level, and a risk value. Each of the threat Level, the vulnerability level, and the business risk level is assessed, for example, in three levels (i.e., classified into three levels). The risk value is assessed, for example, in five levels (i.e., classified into five levels) according to the combination of the threat level, the vulnerability level, and the business risk level.

Note that the asset-based risk analysis and the business impact-based risk analysis do not need to be exactly the same as the asset-based risk analysis and the business impact-based risk analysis, respectively, disclosed in Non-patent Literature 1.

The analysis result collecting unit 101 collects, for each asset, vulnerability information for an attack made in the system to be analyzed.

Specifically, the analysis result collecting unit 101 collects information in regard to the vulnerability present in the asset on which the attack could be made, such as identification information of the vulnerability, information about the presence/absence of a proof-of-attack code, and information about an attack method that can be used. Note that the proof-of-attack code may be a code for checking the presence of a volatility, provided by a vendor, an attack module included in an intrusion investigation tool, or information indicating whether or not an attack method is laid open to the public. Note that the vulnerability information collected by the analysis result collecting unit 101 may be information available from information open to the public, such as information as to whether or not a user is involved in the vulnerability present in the asset on which the attack could be made. Further, the vulnerability information collected by the analysis result collecting unit 101 may be information as to whether or not vulnerable software is software installed by default.

The analysis result collecting unit 101 stores the collected business impact-based risk analysis result, the asset-based risk analysis result, and the vulnerability information in the corresponding DBs. For example, the analysis result collecting unit 101 collects, at regular intervals, a plurality of business impact-based risk analysis results and a plurality of asset-based risk analysis results that are obtained by making assessments in different periods. The analysis result collecting unit 101 stores the collected business impact-based risk analysis results in the business impact-based risk analysis result DB 105. Further, the analysis result collecting unit 101 accumulates the collected asset-based risk analysis results in the asset-based risk analysis result DB 104.

Further, the analysis result collecting unit 101 accumulates vulnerability information obtained in respective assessment periods in the vulnerability DB 106.

The analysis result comparison unit 102 acquires a plurality of risk analysis results obtained in different assessment periods from the asset-based risk analysis result DB 104. For example, the analysis result comparison unit 102 acquires a current (the latest) asset-based risk analysis result and a previous (immediately before the latest) asset-based risk analysis result from the asset-based risk analysis result DB 104. The analysis result comparison unit 102 corresponds to the comparison means 11 shown in FIG. 1. The previous and current asset-based risk analysis results correspond to the risk analysis results 13 and 14, respectively, shown in FIG. 1.

The analysis result comparison unit 102 compares these asset-based risk analysis results with each other, and extracts a difference between them. For example, the analysis result comparison unit 102 extracts, as the difference, a combination of an asset and an attack method that are not present in the previous asset-based risk analysis result, but are present in the current asset-based risk analysis result. The combination of the asset and the attack method extracted as the difference corresponds to a combination of an asset and an attack method that have become newly available during a period between the previous and current assessment periods.

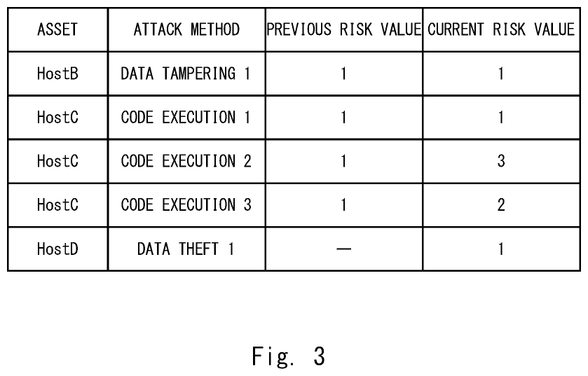

FIG. 3 shows a specific example of a result of a comparison between asset-based risk analysis results. For example, the analysis result comparison unit 102 compares, for each of combination of an asset and an attack method, a risk value in the previous risk analysis result (a previous risk value) and a risk value in the current risk analysis result (a current risk value). Referring to FIG. 3, for example, regarding a combination of an asset “HostB” and an attack method “Data Tampering 1”, the previous risk value is “1” and the current risk value is also “1”, so it means that there has been no change in the risk value.

Meanwhile, for example, regarding a combination of an asset “HostD” and an attack method “Data Theft 1”, the previous risk value is “−(Null)” and the current risk value is “1”. This combination of the asset “HostD” and the attack method “Data Theft 1” corresponds to a combination of an asset and an attack method that has become available during a period between the previous and current assessment periods. For example, the analysis result comparison unit 102 extracts, as the difference, a combination of an asset and an attack method for which the previous risk value is not present and the current risk value is present.

Further, the analysis result comparison unit 102 acquires the current and previous business impact-based risk analysis results from the business impact-based risk analysis result DB 105. The previous and current business impact-based risk analysis results correspond to the risk analysis results 13 and 14, respectively, shown in FIG. 1.

The analysis result comparison unit 102 compares these business impact-based analysis results with each other, and extracts a difference between them. For example, the analysis result comparison unit 102 extracts, as the difference, an attack step that is not included in the previous business impact-based risk analysis result, but is included in the current business impact-based risk analysis result. The attack step extracted as the difference corresponds to an attack step that has newly appeared during a period between the previous and current assessment periods.

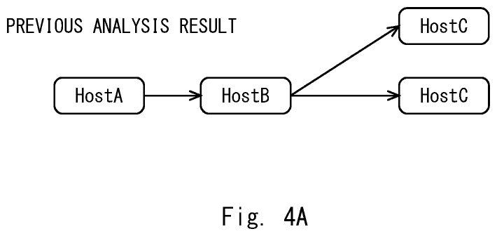

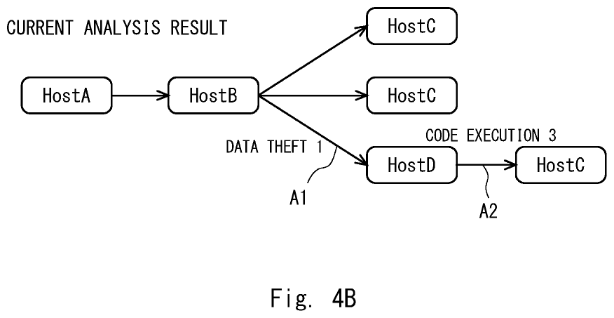

FIG. 4A shows an attack tree that is assessed in the previous business impact-based risk analysis result. FIG. 4B shows an attack tree that is assessed in the current business impact-based risk analysis result. Each of FIGS. 4A and 4B shows an attack tree in which a HostA is an entry point and a HostC is an attack target. In this example, the attack tree includes a plurality of attack paths. Each of the attack paths includes at least one attack step. In the following description, an attack step may be expressed as “Attack Source-[Attack Means]->Attack Destination”.

When the attack trees shown in FIG. 4A and FIG. 4B are compared with each other, an attack step A1 from a HostB to a HostD, and an attack step A2 from the HostD to the HostC have been added in the current risk analysis result. The attack step A1 expressed as “HostB-[Data Theft 1]->HostD” and the attack step A2 expressed as “HostD-[Code execution 3]->HostC” correspond to attack steps that have newly appeared during a period between the previous and current assessment periods. The analysis result comparison unit 102 extracts these attack steps A1 and A2 as differences.

Note that it is possible to determine that the attack step A1, which branches off from an already-present attack path, is an attack step that has newly become available for the attack in the current assessment period (a new attack step) because of, for example, the discovery of a new vulnerability. In contrast, it is not possible to determine that the attack step A2, which is subsequent to the attack step A1, is an attack step in which a new vulnerability is used. For example, there is a possibility that the attack step A2 may not have been present in the attack path because, though the attack method “Code execution 3” for the HostC has already been available for the attack, the attack has not been able to be made on the HostD. In such a case, it is considered that the attack step A2 is an attack step of which the risk has become apparent as the attack step A1 became available.

In this example embodiment, the analysis result comparison unit 102 may classify attack steps extracted as differences into new attack steps (second type attack steps) and attack steps of which the risks have become apparent (first type attack steps). For example, the analysis result comparison unit 102 examines whether or not a combination of the asset at the attack destination of the attack step extracted as the difference and its attack method is present in the previous asset-based risk analysis result. When the combination of the asset at the attack destination and its attack method is present only in the current asset-based risk analysis result, and is not present in the previous asset-based risk analysis result, the analysis result comparison unit 102 determines that its attack step is a new attack step. When the combination of the asset at the attack destination and its attack method is present in both the current and previous asset-based risk analysis results, the analysis result comparison unit 102 determines that its attack step is an attack step of which the risk has become apparent.

The analysis result comparison unit 102 acquires the previous vulnerability information and the current vulnerability information from the vulnerability DB. The analysis result comparison unit 102 compares differences between these two pieces of vulnerability information, and detects information that has newly appeared in the current analysis result, such as the vulnerability of the asset, an attack method for the asset, and the presence/absence of a proof-of-attack code. The analysis result comparison unit 102 compares the vulnerability information detected in the comparison of the vulnerability information with the comparison of the business impact-based risk analysis results and with the attack steps detected in the asset-based risk analysis results.

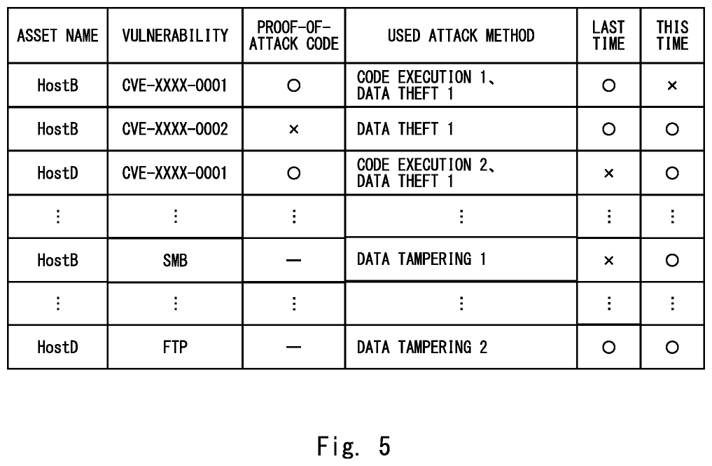

FIG. 5 shows a result of a comparison between previous and current vulnerability information. In FIG. 5, “Asset Name” indicates assets constituting a system, and Vulnerability indicates identifiers for identifying vulnerabilities. The vulnerabilities include software vulnerabilities and protocol vulnerabilities. For the identifiers of software vulnerabilities, for example, CVE (Common Vulnerabilities and Exposures) can be used. For the identifiers of protocol vulnerabilities, names of protocols, such as an SMB (Server Message Block) and an FTP (File Transfer Protocol), can be used.

“Proof-of-Attack Code” indicates whether or not there is a proof-of-attack code, and “Used Attack Method” indicates for which attack method the vulnerability can be used. “Last Time” indicates whether or not a combination of an asset and a vulnerability is included in the previous risk analysis result, and “This Time” indicates whether or not the combination of the asset and the vulnerability is included in the previous risk analysis result. As shown in FIG. 5, the analysis result comparison unit 102 detects that a vulnerability “CVE-XXXX-0001” for an asset “HostD” has newly appeared.

Note that, in the above description, the analysis result comparison unit 102 compares the current asset-based risk analysis result with the previous asset-based risk analysis result, and compares the current business impact-based risk analysis result with the previous business impact-based risk analysis result. This example embodiment is not limited to the above-described example. The analysis result comparison unit 102 may compare an asset-based risk analysis result and a business impact-based risk analysis result obtained at an arbitrary time point in the past with an asset-based risk analysis result and a business impact-based risk analysis result, respectively, obtained at an arbitrary time point different from the aforementioned time point. The same applies to the comparison for the vulnerability DB.

The analysis result comparison unit 102 stores the comparison results of the business impact-based risk analysis results, those of the asset-based risk analysis results, and those of the vulnerability information in the comparison result DB 107.

The result display unit 103 visualizes the comparison results of the business impact-based risk analysis results, those of the asset-based risk analysis results, and those of the vulnerability information for a user. For example, the result display unit 103 displays comparison results stored in the comparison result DB 107 on a display device or the like (not shown in the drawings). The result display unit 103 displays the comparison results in the form of a graph or a table for a user. The result display unit 103 corresponds to the output means 12 shown in FIG. 1.

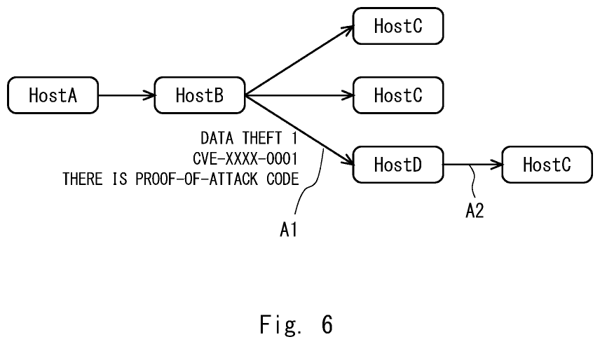

FIG. 6 shows an example of a displayed comparison result. FIG. 6 shows an attack path in which a HostA is an entry point and a HostC is an attack target. For an attack step A1, which is a new attack step, the analysis result comparison unit 102 determines, from the comparison result of the vulnerability information (see FIG. 5), that a vulnerability “CVE-XXXX-0001” that can be used for an attack method “Data Theft 1” is a newly detected vulnerability. The analysis result comparison unit 102 adds, to the attack step A1, information such as the vulnerability “CVE-XXXX-0001” and “There is Proof-of-Attack Code” associated with that vulnerability. For example, as shown in FIG. 6, the result display unit 103 may display, for the attack step A1, which is a new attack step, the vulnerability to be used, the presence/absence of a proof-of-attack code for that vulnerability, and the like in the attack tree expressed in the structure of a graph.

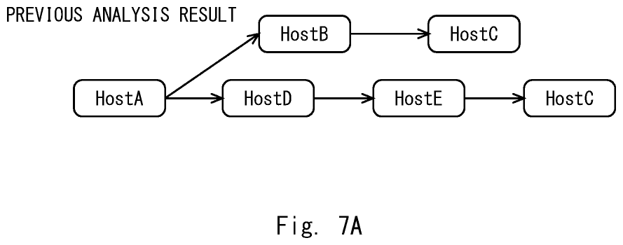

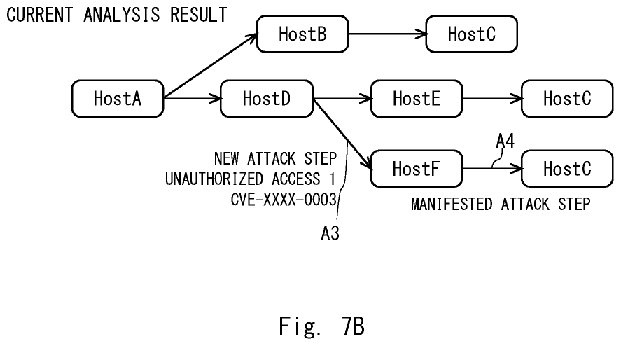

Each of FIGS. 7A and 7B shows another example of a displayed comparison result. Each of FIGS. 7A and 7B shows an attack tree in which a HostA is an entry point and a HostC is an attack target. FIG. 7A shows an attack tree in the previous business impact-based risk analysis result, and FIG. 7B shows an attack tree in the current business impact-based risk analysis result. The result display unit 103 may display the attack trees shown in FIGS. 7A and 7B side by side.

When the attack trees shown in FIG. 7A and FIG. 7B are compared with each other, attack steps A3 and A4 have been added in the attack path in the current risk analysis result. The attack step A3 is a new attack step, and attack step A4 is an attack step of which the risk has become apparent as the attack step A3 has appeared (also referred to as a manifested attack step). The result display unit 103 may display the new attack step and the manifested attack step (i.e., the attack step that has become apparent) in display modes different from each other. For example, the result display unit 103 may display an arrow indicating the attack step A3, which is the new attack step, in red, and an arrow indicating the attack step A4, which is the manifested attack step, in blue.

The result display unit 103 may display the attack step A3 together with the vulnerability “CVE-XXXX-0003” used in the new attack step. The result display unit 103 may also display the attack step A3 together with information about the vulnerability, such as the presence/absence of a proof-of-attack code and/or information as to whether or not a user is involved. Similarly, the result display unit 103 may display the attack step A4, which is the manifested attack step, together with information about the vulnerabilities used in the attack step. Further, the result display unit 103 may also display the attack step A4 together with information about the vulnerability, such as the presence/absence of a proof-of-attack code and/or information as to whether or not a user is involved.

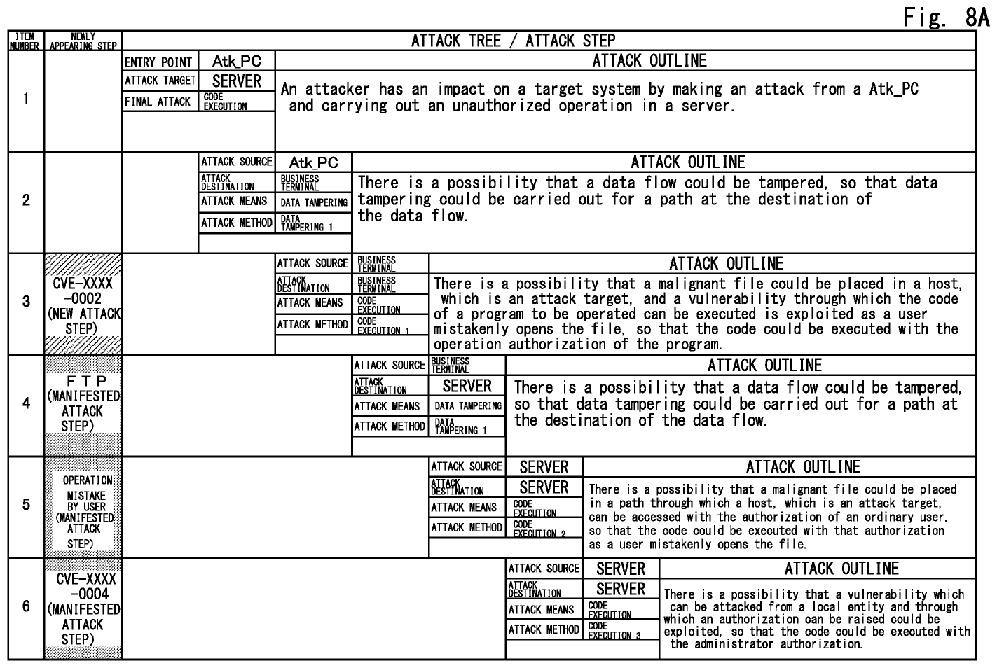

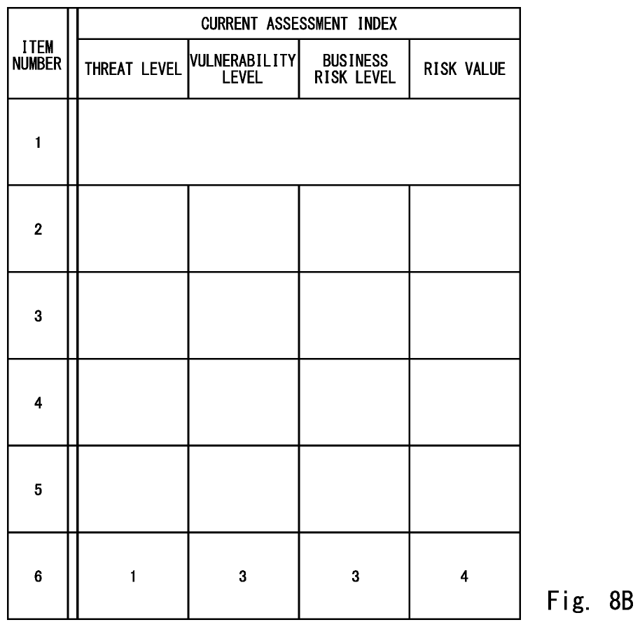

Each of FIGS. 8A and 8B shows yet another example of a displayed comparison result. In this example of a displayed comparison result, new attack steps and manifested attack steps are displayed together with the business impact-based risk analysis result. In FIGS. 8, the business impact-based risk analysis result includes columns for Item Number, Attack Tree/Attack Step, and Current Assessment Index. In the Attack Tree/Attack Step in FIG. 8A or 8B, each attack step is shown as one of records indicated by item numbers “2” to “6”. The attack tree includes the attack steps indicated by the item numbers “2” to “6”. The current assessment index includes a threat level, a vulnerability level, a business risk level, and a risk value. In this example, the assessment index is added to the entire attack path, instead of being added to each individual attack step.

The result display unit 103 adds, for example, an item representing a “Newly Appearing Step” in the table showing the business impact-based risk analysis result. The “Newly Appearing Step” indicates that the attack step is a new attack step or a manifested attack step. For example, when an attack step identified by an item number is a new attack step, the result display unit 103 displays the cell (its background color) in red. When an attack step identified by an item number is a manifested attack step, the result display unit 103 displays the cell in blue. The result display unit 103 may display the entire row (each cell in the row) identified by an item number in red or in blue. The result display unit 103 may display information about the vulnerability used in the attack step in the column “Newly Appearing Step”.

For example, assume that, in FIG. 8A or 8B, an attack step identified by an “item number” 3 is a new attack step, and attack steps identified by item numbers “4” to “6” are manifested attack steps. In this case, the result display unit 103 sets the background color of the cell of the “Newly Appearing Step” corresponding to the item number “3” to red. The result display unit 103 displays a vulnerability “CVE-XXXX-0002” used in the new attack step in the cell of the “Newly Appearing Step”. Further, the result display unit 103 sets the background color of the cell of the “Newly appeared step” corresponding to each of the item numbers “4” to “6” to blue. The result display unit 103 displays, in the cells of the “Newly Appearing step”, vulnerabilities used in respective manifested attack steps.

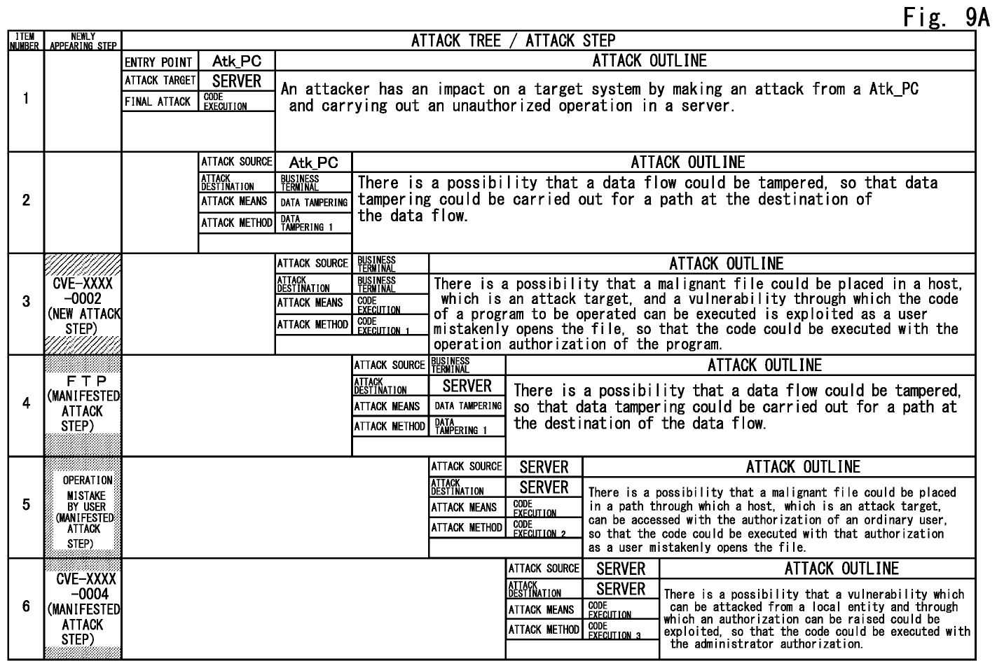

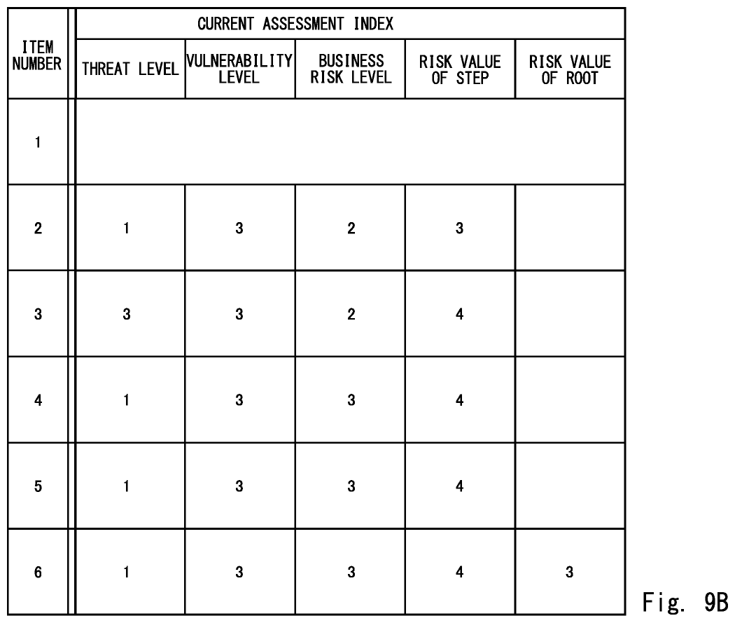

Each of FIGS. 9A and 9B shows yet another example of a displayed comparison result. In this example of a displayed comparison result, similarly to the example of a displayed comparison result shown in FIG. 8A or 8B, new attack steps and manifested attack steps are displayed together with the business impact-based risk analysis result. In this example of a displayed comparison result, the assessment index is added to each attack step and to the entire attack path. The step risk value indicates a risk value assessed for each attack step. The risk value of the root indicates a risk value assessed for the entire attack path. The “Newly Appearing Step” in this example of a displayed comparison result is similar to that in the example of a displayed comparison result shown in FIG. 8A or 8B.

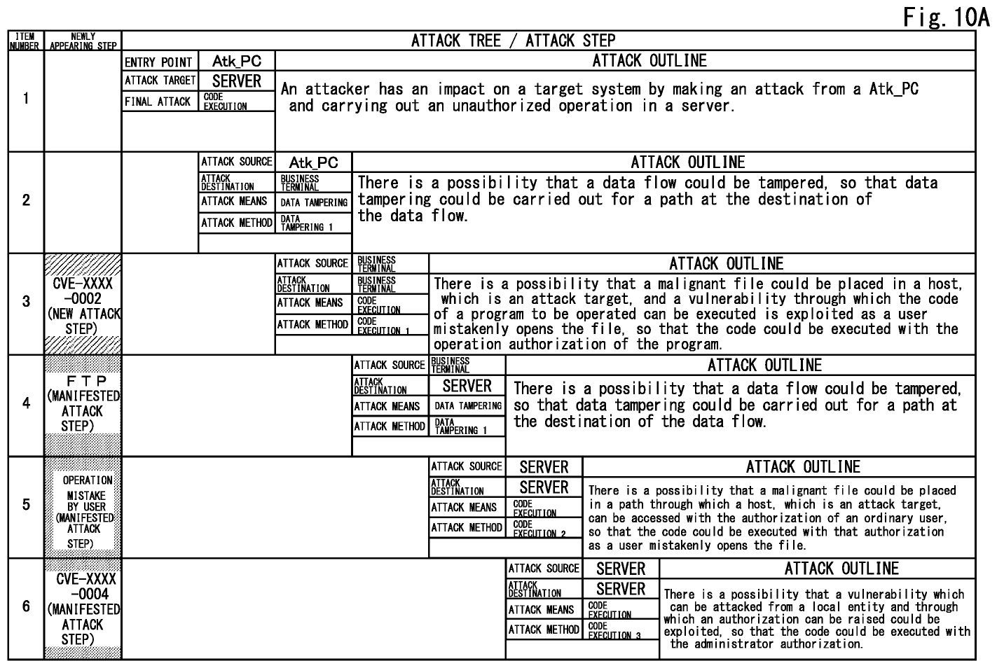

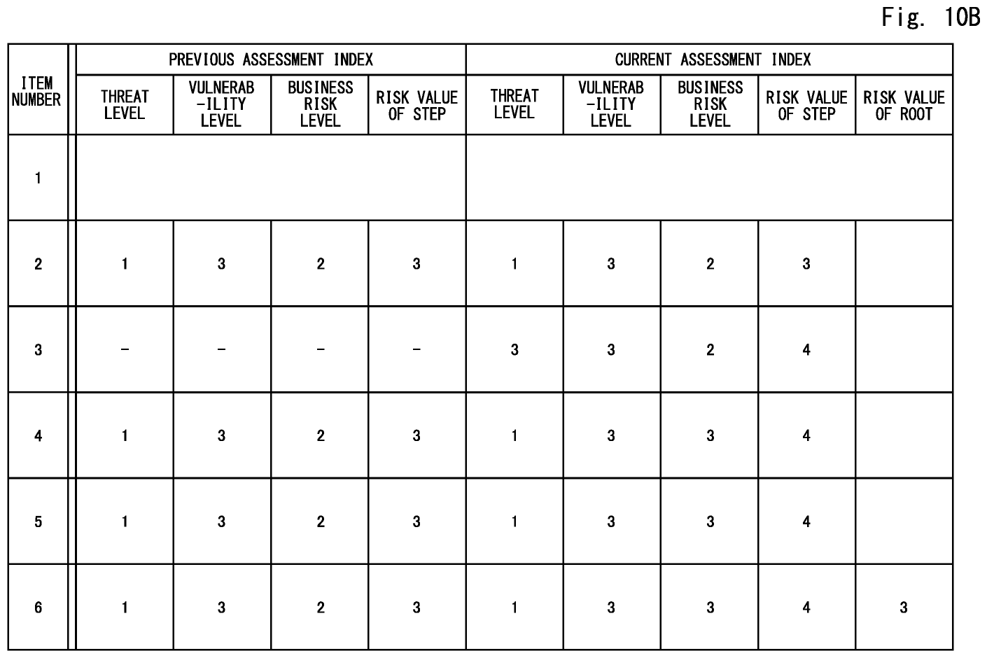

Each of FIGS. 10A and 10B shows yet another example of a displayed comparison result. In this example of a displayed comparison result, similarly to the example of a displayed comparison result shown in FIG. 9A or 9B, new attack steps and manifested attack steps are displayed together with the business impact-based risk analysis result. In this example of a displayed comparison result, assessment indices in the previous business impact-based risk analysis result are displayed in addition to those in the current business impact-based risk analysis result. The “Newly Appearing step” in this example of a displayed comparison result is similar to that in the example of the displayed comparison result in FIG. 8A or 8B.

In the example shown in FIG. 9A or 9B, current assessment indices and previous assessment indices are displayed in such a manner that they can be compared to each other. In this way, a user can easily compare the current assessment indices with the previous assessment indices. For example, for the attack step in the item number “3,” the user can recognize that this attack step is a new attack step because, in addition to that the cell in the “Newly Appearing Step” is displayed in red, the previous assessment index is represented by “−” which indicates that there is no assessment value.

As described above, by changing the display color of new attack steps from that of manifested attack steps, the user can easily determine whether or not the attack step is an attack step that has newly become available for the attack, or whether or not the attack step is an attack step of which the risk has become apparent as a new attack step has appeared. Further, by displaying vulnerabilities used in new attack steps and manifested attack steps while associating them with the new attack steps and the manifested attack steps, the user can determine against which vulnerability(ies) countermeasures should be taken.

Note that although an example in which the result display unit 103 displays (i.e., adds) a new attack step(s) and a manifested attack step(s) in a business impact-based risk analysis result has been described in the above description, this example embodiment is not limited to such examples. The result display unit 103 may display (i.e., add) a new attack step(s) and a manifested attack step(s) in an asset-based risk analysis result.

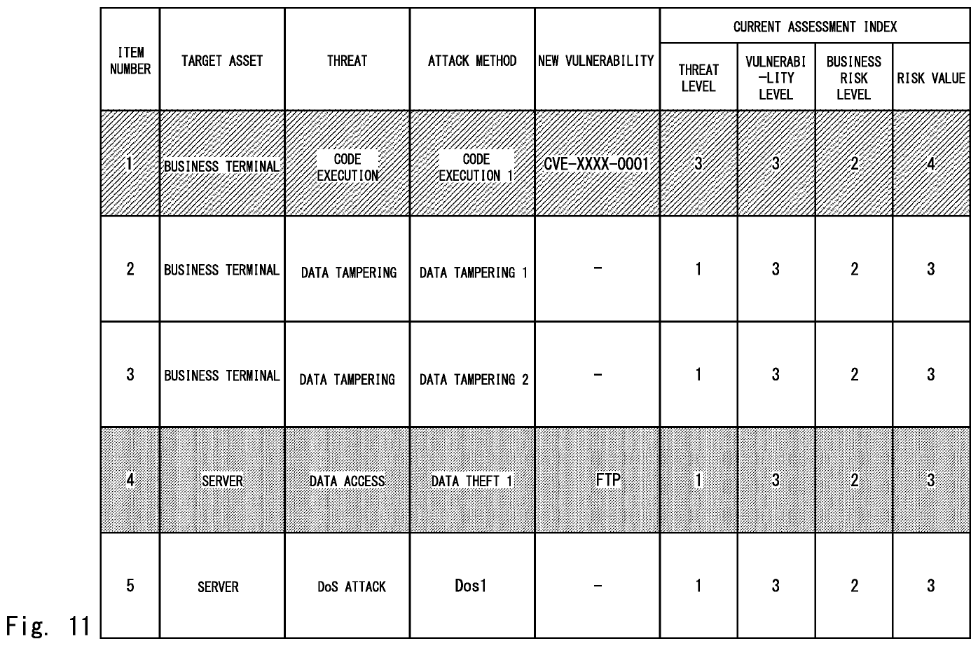

FIG. 11 shows an example in which a new attack step and a manifested attack step are displayed (i.e., added) in an asset-based risk analysis result. The asset-based risk analysis result includes columns for Item Number, Target Asset, Threat, Attack Method, and Assessment Index. For example, when an asset and an attack method are same as the asset at the attack destination of a new attack step and the attack method thereof, the result display unit 103 displays each cell in the row (its background color) in red. For example, when an asset and an attack method are same as the asset and the attack method of a manifested attack step, the result display unit 103 displays each cell in the row (its background color) in blue. Further, the result display unit 103 adds, for example, an item (i.e., a column) showing “new vulnerabilities” in the table showing the business impact-based risk analysis result. The “new vulnerabilities” indicate vulnerabilities used in the new attack step and the manifested attack step.

For example, assume that, in the comparison between business impact-based risk analysis results, it has been determined that the attack step of which the attack destination is a “Business Terminal” and the attack method is an “Code execution 1” is a new attack step. In this case, the result display unit 103 makes the background color of each cell in the row of the item number “1” corresponding to the combination of the target asset “Business Terminal” and “Attack Method” red. Further, assume that, in the comparison between business impact-based risk analysis results, it has been determined that the attack step of which the attack destination is a “Server” and the attack method is “FTP” is a manifested attack step. In this case, the result display unit 103 makes the background color of each cell in the row of the item number “1” corresponding to the combination of the target asset “Server” and the attack method “FTP” blue. By doing so, the user can identify the combinations of the assets and the attack methods corresponding to the new attack step and the manifested attack step in the asset-based risk analysis result.

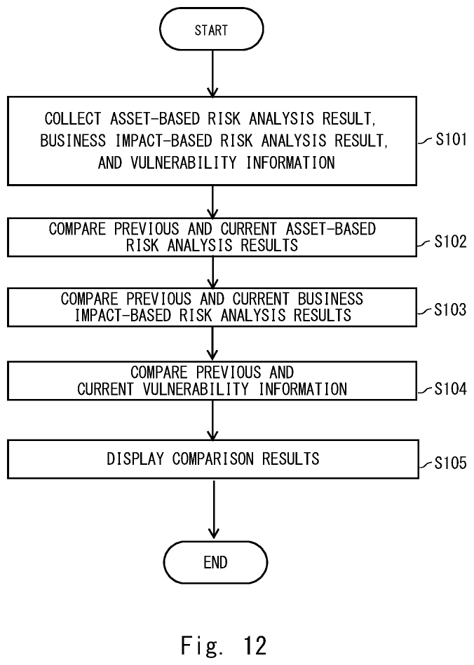

An operation procedure (a risk analysis result display method) performed by the risk analysis result display apparatus 100 according to this example embodiment will be described hereinafter. FIG. 12 shows an operating procedure performed by the risk analysis result display apparatus 100. The analysis result collecting unit 101 stores a business impact-based risk analysis result in the business impact-based risk analysis result DB 105. Further, the analysis result collecting unit 101 stores an asset-based risk analysis result in the asset-based risk analysis result DB 104. Further, the analysis result collecting unit 101 stores vulnerability information in the vulnerability DB 106 (Step S101).

The analysis result comparison unit 102 acquires, for example, the previous asset-based risk analysis result and the current asset-based risk analysis result from the asset-based risk analysis result DB 104. The analysis result comparison unit 102 compares these analysis results with each other (Step S102). As a result of the comparison, the analysis result comparison unit 102 extracts a difference between the previous and current asset-based risk analysis results.

The analysis result comparison unit 102 acquires the previous business impact-based risk analysis result and the current business impact-based risk analysis result from the business impact-based risk analysis result DB 105, and compares these analysis results with each other (Step S103). As a result of the comparison, the analysis result comparison unit 102 extracts an attack step(s) that has newly appeared in the current business impact-based risk analysis result.

The analysis result comparison unit 102 classifies the above-described newly-appearing attack steps into attack steps that have become available by using a new vulnerability(ies) and attack steps that have become available by using a known vulnerability(ies). This classification can be performed by using the asset-based risk analysis results when the business impact-based risk analysis results do not include a risk value for each attack step (see the example shown in FIG. 8A or 8B). The above-described classification can be performed by comparing the previous and current business impact-based risk analysis results when the business impact-based risk analysis results include a risk value for each attack step (see the example in FIG. 9A or 9B).

The analysis result comparison unit 102 compares the differences of the previous vulnerability information and the current vulnerability information (Step S104). For example, the analysis result comparison unit 102 compares assets, vulnerabilities that can be used for the attack on the assets, the presence/absence of proof-of-attack codes, and attack methods that can be used for the attack of the previous analysis result with those of the current analysis result. In the step S104, the analysis result comparison unit 102 detects that, for example, a vulnerability “CVE-XXXX-0001” for an asset “HostD” has newly appeared in the example shown in FIG. 5.

The analysis result comparison unit 102 stores the comparison result of the business impact-based risk analysis, that of the asset-based risk analysis, and that of the vulnerability information in the comparison result DB 107. The analysis result comparison unit 102 may store the asset-based risk analysis result, the business impact-based risk analysis result, and the vulnerability information used in the comparison performed in the steps S102 to S104 in the comparison result DB 107.

The result display unit 103 displays a comparison result(s) stored in the comparison result DB 107 on a display device or the like (not shown in the drawings) (Step S105). For example, the result display unit 103 can display, for a user, the comparison result in the form of a graph or a table. For example, the result display unit 103 may graphically display a new attack step(s) and a manifested attack step(s) in an attack tree as shown in FIGS. 6, 7A and 7B. Alternatively, the result display unit 103 may display a new attack step(s) and a manifested attack step(s), for example, in the business impact-based risk analysis result or the asset-based risk analysis result in such a manner that they can be identified from each other as shown in FIG. 8A or 8B to FIG. 11. For example, the user may select the new attack step or the manifested attack step in the graphically displayed attack tree. In such a case, the result display unit 103 may display details of the analysis result in the business impact-based risk analysis result or the asset-based risk analysis result corresponding to the attack step.

In this example embodiment, the analysis result comparison unit 102 compares two risk analysis results of which assessment periods differ from each other. For example, the analysis result comparison unit 102 compares the previous and current business impact-based risk analysis results with each other, and extracts an attack step(s) that has become newly available for the attack. The result display unit 103 presents (i.e., shows), for the user, the difference which is extracted as a result of the comparison. By doing so, the user can easily recognize a difference(s) between the two risk analysis results. For example, the user can easily recognize an attack step(s) that has newly become available for the attack. Therefore, the user can easily recognize changes in the risk, such as which asset(s) in the system a vulnerability(ies) has been occurring, and thereby easily work out security measures.

Note that when an assessment index is added to the entire attack path in the business impact-based risk analysis result, it is not possible to identify (i.e., determine) whether or not an attack step that has newly become available is an attack step in which a new vulnerability is used or an attack step in which a known vulnerability is used. In this example embodiment, the analysis result comparison unit 102 identifies (i.e., determines), by using the asset-based risk analysis result, whether or not an attack step that has newly become available is an attack step in which a new vulnerability is used or an attack step in which a known vulnerability is used. By doing so, the user can identify, among attack steps that have newly become available for the attack, a new attack step that has become available for the attack as a new vulnerability is found. Further, the user can identify a manifested attack step which has become available for the attack as a new attack step has appeared, and in which a known vulnerability is used. The user may, for example, make an assessment(s) only for a new attack step(s), thus making it possible to improve the efficiency of the assessment.

### Second Example Embodiment

Next, a second example embodiment according to the present disclosure will be described. A configuration of a risk analysis result display apparatus according to this example embodiment may be similar to that of the risk analysis result display apparatus described in the first example embodiment shown in FIG. 2. In this example embodiment, the analysis result comparison unit 102 extracts, as a difference, a part(s) of which the assessment index of the current risk analysis result has changed from that of the previous risk analysis result. The other features may be similar to those in the first example embodiment.

The analysis result comparison unit 102 acquires the previous asset-based risk analysis result and the current asset-based risk analysis result from the asset-based risk analysis result DB 104. The analysis result comparison unit 102 compares assessment indices in these asset-based risk analysis result with each other. For example, the analysis result comparison unit 102 compares, for each combination of an asset and an attack method, “risk values” with each other. The analysis result comparison unit 102 extracts, for example, an attack method(s) for which the difference between assessment values is larger than or equal to a threshold. For example, the threshold is set in advance by a user. The analysis result comparison unit 102 may, for example, compare the previous assessment value with the current assessment value for a combination of an asset and an attack method corresponding to an attack step that is assessed in the business impact-based risk analysis result.

In result of the comparison between the asset-based risk analysis results shown in FIG. 3, the analysis result comparison unit 102 extracts, as a difference, a combination of an asset and an attack method for which the difference between the previous and current risk values is larger than or equal to the threshold. In the example shown in FIG. 3, the risk value of the attack method “Code execution 2” for the asset “HostC” has increased from “1” to “3”. When the threshold is “2”, the analysis result comparison unit 102 extracts the combination of the asset “HostC” and the attack method “Code execution 2” as an attack method of which the risk has newly increased. The analysis result comparison unit 102 may compare, instead of comparing the “risk values,” a value such as a “threat level,” a “vulnerability level,” or a “business risk level” of the previous asset-based risk analysis result with that of the asset-based risk analysis result.

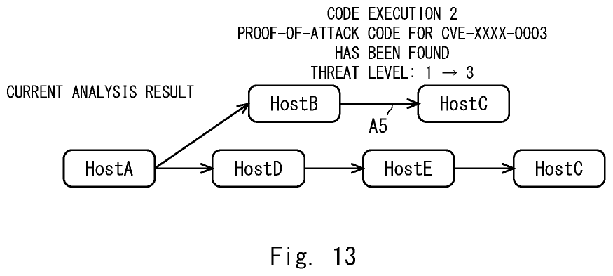

The result display unit 103 displays the comparison result of the analysis result comparison unit 102. For example, the result display unit 103 may display an attack step(s) of which the assessment value has significantly changed in the attack tree as an attack step(s) of which the risk has increased. FIG. 13 shows an example of a displayed comparison result. It is possible to create an attack tree by referring to the current business impact-based risk analysis result. For example, the analysis result comparison unit 102 extracts a combination of the asset “HostC” and the attack method “Code execution 2” as an attack method of which the risk has newly increased. In that case, the result display unit 103 displays, in the attack tree, an attack step A5, in which the “Code execution 2” from the HostB to the HostC is used, as an attack step of which the risk has increased. The result display unit 103 displays, for example, an arrow indicating the attack step A5 in a predetermined color, e.g., in green. By referring to (i.e., seeing) the color of the arrow, the user can recognize of which attack step the risk has increased.

The result display unit 103 may display the attack step A5 together with vulnerability information used in the attack step A5. Further, when an attack step of which the risk has increased is specified based on the “threat level”, the result display unit 103 may display how the threat level of the current result changed from that of the previous result. For example, the result display unit 103 may display “Threat Level: 1->3” in association with the attack step A5. In such a case, the user can recognize that the threat level of that attack step has changed from “1” to “3”.

When the threat level has changed from “1” to “3”, the result display unit 103 may, for example, specify based on what the threat level has changed (i.e., why the threat level has changed), and display the reason why the threat level has been specified. For example, assume that, for the vulnerability used in the attack step A5, there was no proof-of-attack code in the previous assessment period, but there is a proof-of-attack code in the current assessment period. In this case, the result display unit 103 may display “Proof-of-attack code for CVE-XXXX-0003 has been Found” for the attack step A5.

Note that although an example in which the result display unit 103 displays an attack step of which the risk has increased in the attack tree has been described in the above description, this example embodiment is not limited to such examples. Similarly to the example shown in FIG. 8A or 8B to FIG. 11, the result display unit 103 may display an attack step(s) of which the risk has increased in the business impact-based risk analysis result or the asset-based risk analysis result.

In this example embodiment, the analysis result comparison unit 102 specifies a combination of an asset and an attack method of which the risk has increased. Further, in this example embodiment, an attack step(s) of which the risk has increased is displayed in the attack tree. By doing so, the user can specify a part(s) for which countermeasures should be preferentially taken. Further, since an attack step of which the risk has increased is specified, the user can, for example, strengthen security measures in an attack step preceding the attack step of which the risk has increased.

### Third Example Embodiment

Next, a third example embodiment according to the present disclosure will be described. A configuration of a risk analysis result display apparatus according to this example embodiment may be similar to that of the risk analysis result display apparatus 100 shown in FIG. 2. In this example embodiment, for example, the analysis result comparison unit 102 extracts, as a difference, an attack step(s) that is not included in the previous business impact-based risk analysis result, but is included in the current business impact-based risk analysis result. Further, the analysis result comparison unit 102 extracts, as a difference, a part(s) of which the assessment index of the current risk analysis result has changed from that of the previous risk analysis result. The other features may be similar to those in the first and second example embodiments.

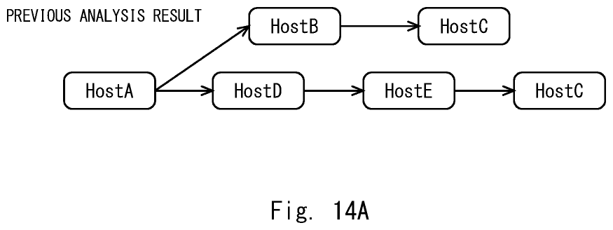

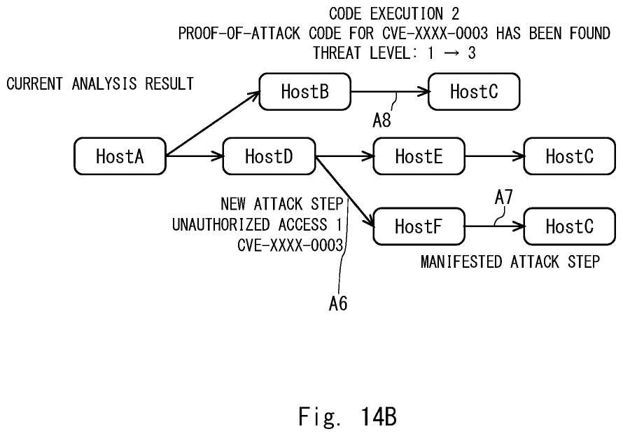

In this example embodiment, the result display unit 103 displays a combination of a table, a graph, or the like of a comparison result in the first example embodiment and that of a comparison result in the second example embodiment. Each of FIGS. 14a and 14b shows an example of a displayed comparison result. The analysis result comparison unit 102 extracts, as new attack steps, attack steps A6 and A7 that are not present in the attack tree shown in FIG. 14A, and are present only in the attack tree shown in FIG. 14B. It is assumed that the attack step A6 is a new attack step and the attack step A7 is a manifested attack step. The attack steps A6 and A7 correspond to the attack steps A3 and A4, respectively, shown in FIG. 7B.

The analysis result comparison unit 102 extracts an attack step A8 that is present in both the attack trees shown in FIGS. 14A and 14B, as an attack step of which the risk has increased. The attack step A8 corresponds to the attack step A5 shown in FIG. 13.

The result display unit 103 displays an arrow indicating the attack step A6, which is a new attack step, in red, and an arrow indicating the attack step A7, which is a manifested attack step, in blue. Further, the result display unit 103 displays an arrow indicating the attack step A8, of which the risk has increased, in green. The result display unit 103 may display vulnerability information used in the attack step A6. Further, regarding the attack step A8, the result display unit 103 may also display the reason why the risk has increased, and how the risk has changed.

In this example embodiment, the result display unit 103 displays a new attack step(s), a manifested attack step(s), and an attack step(s) of which the risk has increased. For example, the result display unit 103 displays a new attack step(s), a manifested attack step(s), and an attack step(s) of which the risk has increased in display modes different from one another. By doing so, it is possible to obtain the effects obtained in the second example embodiment as well as those obtained in the first example embodiment, so that a user can efficiently make an assessment.

### Fourth Example Embodiment

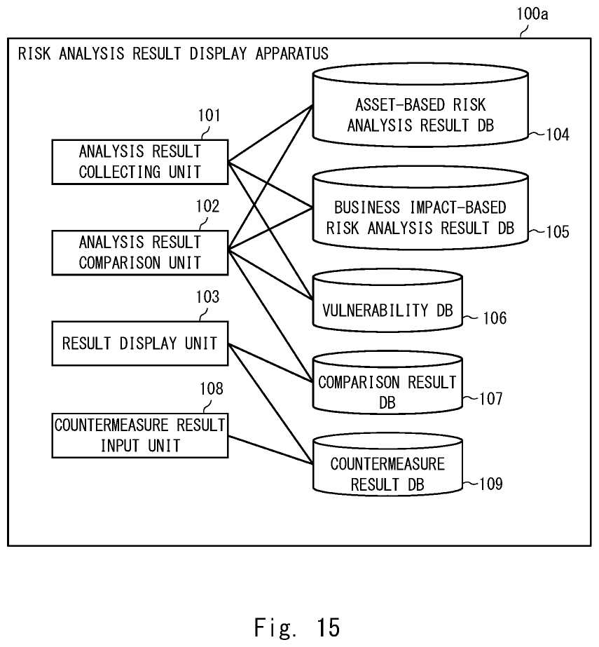

Next, a fourth example embodiment according to the present disclosure will be described. FIG. 15 shows a risk analysis result display apparatus according to the fourth example embodiment of the present disclosure. A risk analysis result display apparatus 100a according to this example embodiment includes a countermeasure result input unit 108 and a countermeasure result DB 109, in addition to the components/structures of the risk analysis result display apparatus 100 according to the first example embodiment. The other features may be similar to those in the first, second or third example embodiment.

Results of countermeasures taken according to risk analysis results are input to the countermeasure result input unit 108. For example, when a user takes security measures against a given attack step, the countermeasure result input unit 108 stores the contents (i.e., details) of the security measures in the countermeasure result DB 109 while associating them with the attack step.

Alternatively, when the user did not take any security measures against a given attack step even though it was necessary to take security measures thereagainst, the countermeasure result input unit 108 stores, for example, the reason why no security measure was taken in the countermeasure result DB 109 while associating the reason with the attack step.

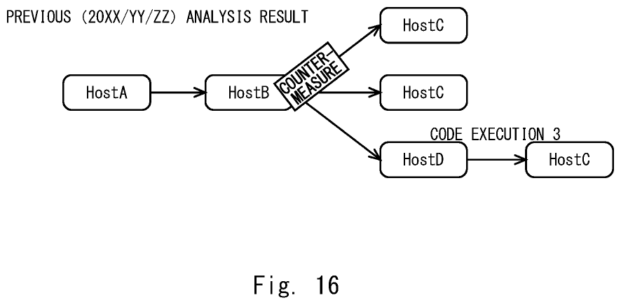

FIG. 16 shows a previous (20XX/YY/ZZ) risk analysis result. FIG. 16 shows an attack tree in which a HostA is an entry point and a HostC is an attack target. The attack tree includes an attack path including an attack step in which an attack method “Code execution 3” from a HostD to the HostC is used. For example, a user takes security measures in a HostB, which precedes the HostD, for an operational reason or the like. In this case, the user does not take any countermeasures for the attack step “HostD-[Code execution 3]-HostC”, and inputs, in the countermeasure result input unit 108, information indicating that the countermeasures were already taken in the preceding entity.

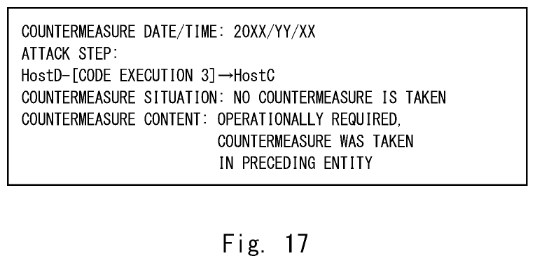

FIG. 17 shows a specific example of a countermeasure result stored in the countermeasure result DB 109. In this example, the countermeasure result includes data for each of the following items: “Countermeasure Date/Time,” “Attack Step,” “Countermeasure Status,” and “Countermeasure Content”. The user determines, for example, not to take any countermeasures for the attack step “HostD-[Code execution 3]-HostC”. In such a case, the countermeasure result DB 109 stores “No countermeasure is taken” as the countermeasure status of the attack step. The user inputs, as the reason why no security measure is taken, “Operationally required, Countermeasure was taken in preceding step”. In this case, the countermeasure result DB 109 stores “Operationally required, Countermeasure was taken in preceding entity” as the contents of the countermeasure.

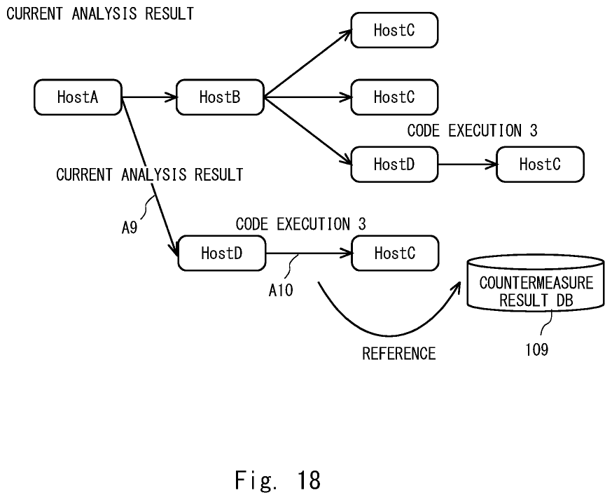

FIG. 18 shows an example of a displayed analysis result. For example, it is assumed that an attack step A9 shown in FIG. 18 is extracted as a new attack step in the comparison between the previous risk analysis result and the current risk analysis result. An attack step A10 subsequent to the new attack step A9 is an attack step of which the risk has become apparent as the new attack step has appeared. The user selects the attack step A10 in order to examine security measures taken against the attack step A10 in the past. As the attack step A10 is selected, the result display unit 103 searches the countermeasure result DB 109 and acquires the “countermeasure status” and the “countermeasure contents” corresponding to that attack step. The result display unit 103 displays the acquired “countermeasure status” and “countermeasure contents” on the display screen.

By referring to (i.e., seeing) the display screen, the user can recognize that no countermeasure has been taken for the attack step “HostD-[Code execution 3]-HostC” because countermeasures were already taken in the HostB preceding the HostD in the previous security measures. Meanwhile, in the current risk analysis result shown in FIG. 18, a new attack step through which the HostD can be directly attacked from the HostA has appeared. Therefore, the user can recognize that some kind of countermeasures need to be taken for the attack step A10.

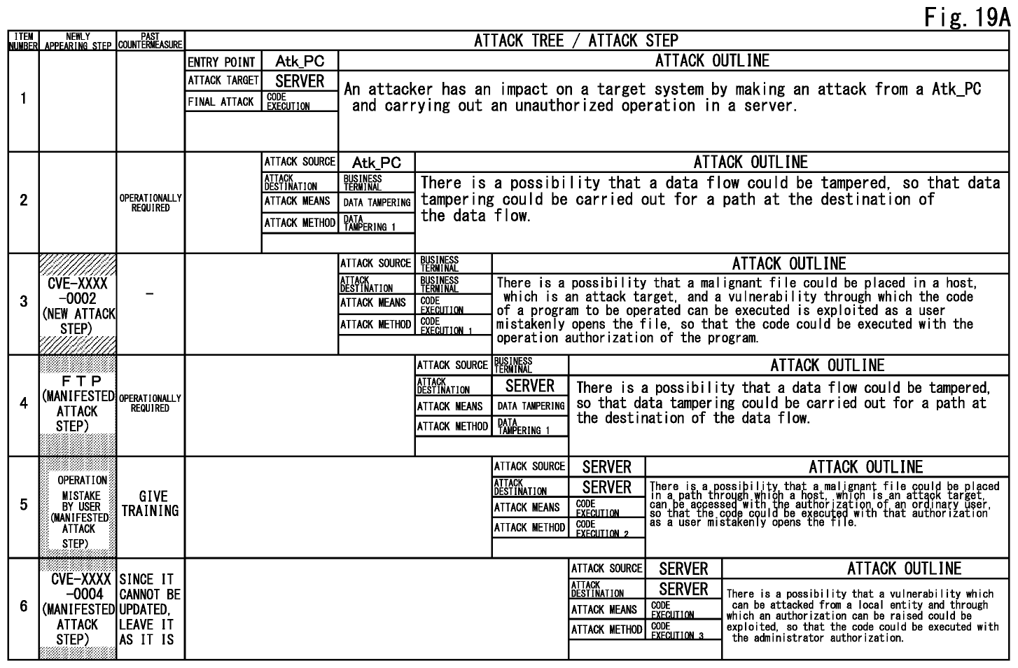

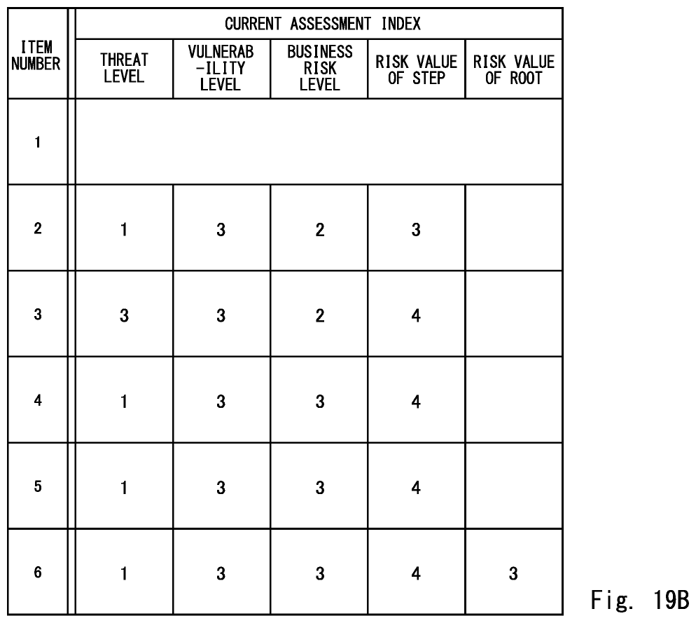

Note that although an example in which when a user selects an attack step, the contents (i.e., details) of countermeasure are displayed has been described in the above description, this example embodiment is not limited to such examples. Information about the contents of countermeasures and the like may be displayed in the asset-based risk analysis result or in the business impact-based risk analysis result. Each of FIG. 19a or 19b shows another example of a displayed analysis result. In this example, contents of countermeasures taken in the past, new attack steps, and manifested attack steps are displayed together with a business impact-based risk analysis result. The structure of the example of the displayed comparison result shown in FIG. 19A or 19B is obtained by adding a column for showing past countermeasures in the example shown in FIG. 10A or 10B. The column for showing past countermeasures may be added in the example shown in FIG. 8A, 8B, 9A or 9B.

The result display unit 103 acquires contents of past countermeasures or the like for each attack step from the countermeasure result DB 109, and enters (i.e., adds) the acquired contents of countermeasures in the column “Past Countermeasure”. For example, the result display unit 103 writes (i.e., adds), for the attack step in the item number “4”, contents of countermeasures “Operationally Required” acquired from the countermeasure result DB 109 in the cell for the past countermeasures. Further, for the attack step in the item number “5,” the result display unit 103 writes (i.e., adds) contents of countermeasures “Give Training” acquired from the countermeasure result DB 109 in the cell for the past countermeasures.

In this example embodiment, contents of past countermeasures are displayed. In the displayed risk analysis result, the user can obtain details of past countermeasures against an attack step(s), and use the obtained past countermeasures for the planning of security measures that should be taken in the future. The other effects are similar to those in the first, second or third example embodiment.

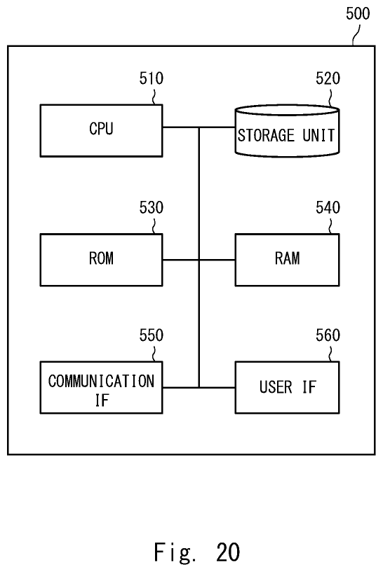

Next, a physical configuration of a risk analysis result display apparatus is described. FIG. 20 shows an example of a configuration of a computer apparatus that can be used as the risk analysis result display apparatus 100, the risk analysis result display apparatus 200, the risk analysis result display apparatus 300, and the risk analysis result display apparatus 400. A computer apparatus 500 includes a control unit (CPU: Central Processing Unit) 510, a storage unit 520, a ROM (Read Only Memory) 530, a RAM (Random Access Memory) 540, a communication interface (IF: Interface) 550, and a user interface (IF) 560.

The communication IF 550 is an interface for connecting the computer apparatus 500 to a communication network through wired communication means or wireless communication means or the like. The user IF 560 includes, for example, a display unit such as a display device. Further, the user IF 560 includes an input unit such as a keyboard, a mouse, and a touch panel.

The storage unit 520 is an auxiliary storage device that can hold various types of data. The storage unit 520 does not necessarily have to be a part of the computer apparatus 500, but may be an external storage device, or a cloud storage connected to the computer apparatus 500 through a network. The storage unit 520 can be used as, for example, at least one of the asset-based risk analysis result DB 104, the business impact-based risk analysis result DB 105, the vulnerability DB 106, and the comparison result DB 107 shown in FIG. 2.

The ROM 530 is a non-volatile storage device. For example, a semiconductor storage device such as a flash memory having a relatively small capacity can be used for the ROM 530. A program(s) that is executed by the CPU 510 may be stored in the storage unit 520 or the ROM 530. The storage unit 520 or the ROM 530 stores, for example, various programs for implementing the function of each unit in the risk analysis result display apparatus 100.

The aforementioned program can be stored and provided to the computer apparatus 500 by using any type of non-transitory computer readable media. Non-transitory computer readable media include any type of tangible storage media. Examples of non-transitory computer readable media include magnetic storage media such as floppy disks, magnetic tapes, and hard disk drives, optical magnetic storage media such as magneto-optical disks, optical disk media such as CD (Compact Disc) and DVD (Digital Versatile Disk), and semiconductor memories such as mask ROM, PROM (Programmable ROM), EPROM (Erasable PROM), flash ROM, and RAM. Further, the program may be provided to a computer using any type of transitory computer readable media. Examples of transitory computer readable media include electric signals, optical signals, and electromagnetic waves. Transitory computer readable media can provide the program to a computer via a wired communication line such as electric wires and optical fibers or a radio communication line.

The RAM 540 is a volatile storage device. As the RAM 540, various types of semiconductor memory apparatuses such as a DRAM (Dynamic Random Access Memory) or an SRAM (Static Random Access Memory) can be used. The RAM 540 can be used as an internal buffer for temporarily storing data and the like. The CPU 510 expands (i.e., loads) a program stored in the storage unit 520 or the ROM 530 in the RAM 540, and executes the expanded (i.e., loaded) program. The function of each unit in the risk analysis result display apparatus 100 can be implemented by having the CPU 510 execute a program. The CPU 510 may include an internal buffer in which data and the like can be temporarily stored.

Although example embodiments according to the present disclosure have been described above in detail, the present disclosure is not limited to the above-described example embodiments, and the present disclosure also includes those that are obtained by making changes or modifications to the above-described example embodiments without departing from the spirit of the present disclosure.

The whole or part of the example embodiments disclosed above can be described as, but not limited to, the following Supplementary notes.

(Supplementary Note 1)

A risk analysis result display apparatus comprising:

comparison means for comparing a risk analysis result obtained by assessing a risk to a system to be analyzed in a first assessment period with a risk analysis result obtained by assessing the risk to the system to be analyzed in a second assessment period different from the first assessment period, and extracting a difference between the risk analysis result obtained in the first assessment period and the risk analysis result obtained in the second assessment period; and output means for displaying the extracted difference for a user.

(Supplementary Note 2)

The risk analysis result display apparatus described in Supplementary note 1, wherein

the risk analysis result includes a first risk analysis result obtained by assessing a risk that arises when an attack is made on the system to be analyzed along an attack path from an entry point included in the system to be analyzed to an attack target, the attack path including at least one attack step including an attack source, an attack destination, and an attack method, and

the comparing means extracts, as the difference, at least one attack step that is not present in the first risk analysis result in the first assessment period, but is present in the first risk analysis result in the second assessment period.

(Supplementary Note 3)

The risk analysis result display apparatus described in Supplementary note 2, wherein the output means displays, for the user, an attack step extracted as the difference in such a manner that an attack step that is present in both the first risk analysis result obtained in the first assessment period and the first risk analysis result obtained in the second assessment period and the attack step extracted as the difference can be distinguished from each other.

(Supplementary Note 4)

The risk analysis result display apparatus described in Supplementary note 2 or 3, wherein

the risk analysis result further includes a second risk analysis result obtained by assessing a risk that arises when an attack is made on an asset in the system to be analyzed by at least one conceivable attack method,

the comparison means further classifies attack steps extracted as the difference into a first type attack step of which a combination of an asset at the attack destination and the attack method is present in both the second risk analysis result obtained in the first assessment period and the second risk analysis result obtained in the second assessment period, and a second type attack step of which a combination of an asset at the attack destination and the attack method is not present in the second risk analysis result obtained in the first assessment period but is present in the second risk analysis result obtained in the second assessment period, and

the output means displays, for the user, the attack step extracted as the difference in such a manner that the first type attack step and the second type attack step can be distinguished from each other.

(Supplementary Note 5)

The risk analysis result display apparatus described in Supplementary note 4, wherein the output means displays, for the user, a vulnerability used in the attack method in the second type attack step while associating the vulnerability with the second type attack step.

(Supplementary Note 6)

The risk analysis result display apparatus described in Supplementary note 5, wherein the output means further displays, for the user, information about the vulnerability.

(Supplementary Note 7)

The risk analysis result display apparatus described in any one of Supplementary notes 4 to 6, further comprising a countermeasure result database configured to store a security measure taken for an asset and an attack method based on the risk analysis result, wherein

the output means further displays, for the user, a security measure taken for an attack destination of the first type attack step, and an asset and an attack method corresponding to the attack destination, acquired from the countermeasure result database.

(Supplementary Note 8)

The risk analysis result display apparatus described in any one of Supplementary notes 4 to 7, wherein the output means graphically displays the attack path on a screen of a display device, and displays, in the graphically-displayed attack path, an attack step that is present in both the first risk analysis result obtained in the first assessment period and the first risk analysis result obtained in the second assessment period, the first type attack step, and the second type attack step in display modes different from one another.

(Supplementary Note 9)

The risk analysis result display apparatus described in any one of Supplementary notes 4 to 7, wherein the output means displays a table showing the first risk analysis result on a display screen of a display device, and displays, in the displayed table showing the first risk analysis result, an attack step that is present in both the first risk analysis result obtained in the first assessment period and the first risk analysis result obtained in the second assessment period, the first type attack step, and the second type attack step in display modes different from one another.

(Supplementary Note 10)

The risk analysis result display apparatus described in any one of Supplementary notes 4 to 7, wherein

the first risk analysis result includes a risk assessment for each attack step, and

the comparison means further specifies an attack step of which a risk assessment in the first risk analysis result obtained in the second assessment period changes from that in the first risk analysis result obtained in the first assessment period, and further extracts the specified attack step as the difference.

(Supplementary Note 11)

The risk analysis result display apparatus described in Supplementary note 10, wherein the output means graphically displays the attack path on a screen of a display device, and displays, in the graphically-displayed attack path, an attack step that is present in both the first risk analysis result obtained in the first assessment period and the first risk analysis result obtained in the second assessment period, the first type attack step, the second type attack step, and the attack step of which the specified risk assessment changes in display modes different from one another.

(Supplementary Note 12)

The risk analysis result display apparatus described in Supplementary note 10, wherein the output means displays a table showing the first risk analysis result on a display screen of a display device, and displays, in the displayed table showing the first risk analysis result, an attack step that is present in both the first risk analysis result obtained in the first assessment period and the first risk analysis result obtained in the second assessment period, the first type attack step, the second type attack step, and the attack step of which the specified risk assessment changes in display modes different from one another.

(Supplementary Note 13)

The risk analysis result display apparatus described in any one of Supplementary notes 4 to 7, wherein the comparison means further specifies an asset and an attack method of which a risk assessment in the second risk analysis result obtained in the second assessment period changes from that in the second risk analysis result obtained in the first assessment period, and further extracts, as the difference, an attack step in which its attack destination and its attack method are the specified asset and the specified attack method.

(Supplementary Note 14)

The risk analysis result display apparatus described in Supplementary note 13, wherein the output means graphically displays the attack path on a screen of a display device, and displays, in the graphically-displayed attack path, an attack step that is present in both the first risk analysis result obtained in the first assessment period and the first risk analysis result obtained in the second assessment period, the first type attack step, the second type attack step, and the attack step in which its attack destination and its attack method are the specified asset and the specified attack method in display modes different from one another.

(Supplementary Note 15)

The risk analysis result display apparatus described in Supplementary note 14, wherein the output means displays a table showing the first risk analysis result on a display screen of a display device, and displays, in the displayed table showing the first risk analysis result, an attack step that is present in both the first risk analysis result obtained in the first assessment period and the first risk analysis result obtained in the second assessment period, the first type attack step, the second type attack step, and the attack step in which its attack destination and its attack method are the specified asset and the specified attack method in display modes different from one another.

(Supplementary Note 16)

The risk analysis result display apparatus described in any one of Supplementary notes 1 to 7, wherein the comparison means extracts, as the difference, an entity to be assessed of which a risk assessment in the risk analysis result obtained in the second assessment period changes from that in the risk analysis result obtained in the first assessment period.

(Supplementary Note 17)

The risk analysis result display apparatus described in Supplementary note 16, wherein

the risk analysis result is a risk analysis result obtained by assessing a risk that arises when an attack is made on the system to be analyzed along an attack path from an entry point included in the system to be analyzed to an attack target, the attack path including at least one attack step including an attack source, an attack destination, and an attack method,

the risk analysis result includes a risk assessment for each attack step, and

the comparison means specifies an attack step of which the risk assessment in the risk analysis result obtained in the second assessment period changes from that in the risk analysis result obtained in the first assessment period, and extracts the specified attack step as the difference.

(Supplementary Note 18)

The risk analysis result display apparatus described in Supplementary note 16, wherein

the risk analysis result is a risk analysis result obtained by assessing a risk that arises when an attack is made on an asset in the system to be analyzed by at least one conceivable attack method, and

the comparison means specifies an asset and an attack method of which the risk assessment in the risk analysis result obtained in the second assessment period changes from that in the risk analysis result obtained in the first assessment period, and extracts the specified asset and attack method as the difference.

(Supplementary Note 19)

The risk analysis result display apparatus described in any one of Supplementary notes 16 to 18, wherein the comparison means extracts, as the difference, an entity to be assessed of which a change of an assessment value of the risk assessment in the risk analysis result obtained in the second assessment period from that in the risk analysis result obtained in the first assessment period is larger than or equal to a predetermined change.

(Supplementary Note 20)

A risk analysis result display method comprising:

comparing a risk analysis result obtained by assessing a risk to a system to be analyzed in a first assessment period with a risk analysis result obtained by assessing the risk to the system to be analyzed in a second assessment period different from the first assessment period;

extracting a difference between the risk analysis result obtained in the first assessment period and the risk analysis result obtained in the second assessment period based on a result of the comparison; and

displaying the extracted difference for a user.

(Supplementary Note 21)

The risk analysis result display method described in Supplementary note 20, wherein

the risk analysis result includes a first risk analysis result obtained by assessing a risk that arises when an attack is made on the system to be analyzed along an attack path from an entry point included in the system to be analyzed to an attack target, the attack path including at least one attack step including an attack source, an attack destination, and an attack method, and

in the extraction of the difference, at least one attack step that is not present in the first risk analysis result in the first assessment period but is present in the first risk analysis result in the second assessment period is extracted as the difference.

(Supplementary Note 22)

The risk analysis result display method described in Supplementary note 21, wherein

the risk analysis result further includes a second risk analysis result obtained by assessing a risk that arises when an attack is made on an asset in the system to be analyzed by at least one conceivable attack method,

the risk analysis result display method further comprises classifying attack steps extracted as the difference into a first type attack step of which a combination of an asset at the attack destination and the attack method is present in both the second risk analysis result obtained in the first assessment period and the second risk analysis result obtained in the second assessment period, and a second type attack step of which a combination of an asset at the attack destination and the attack method is not present in the second risk analysis result obtained in the first assessment period but is present in the second risk analysis result obtained in the second assessment period, and

the displaying the difference for the user comprises displaying, for the user, the attack step extracted as the difference in such a manner that the first type attack step and the second type attack step can be distinguished from each other.

(Supplementary Note 23)

A non-transitory computer readable medium storing a program for causing a computer to perform a process of:

comparing a risk analysis result obtained by assessing a risk to a system to be analyzed in a first assessment period with a risk analysis result obtained by assessing the risk to the system to be analyzed in a second assessment period different from the first assessment period;

extracting a difference between the risk analysis result obtained in the first assessment period and the risk analysis result obtained in the second assessment period based on a result of the comparison; and

displaying the extracted difference for a user.

### REFERENCE SIGNS LIST

10 RISK ANALYSIS RESULT DISPLAY APPARATUS
11 COMPARISON MEANS
12 OUTPUT MEANS
13 RISK ANALYSIS RESULT
14 RISK ANALYSIS RESULT
100 RISK ANALYSIS RESULT DISPLAY APPARATUS
100a RISK ANALYSIS RESULT DISPLAY APPARATUS
101 ANALYSIS RESULT COLLECTING UNIT
102 ANALYSIS RESULT COMPARISON UNIT
103 RESULT DISPLAY UNIT
104 ASSET-BASED RISK ANALYSIS RESULT DB
105 BUSINESS IMPACT-BASED RISK ANALYSIS RESULT DB
106 VULNERABILITY DB
107 COMPARISON RESULT DB
108 COUNTERMEASURE RESULT INPUT UNIT
109 COUNTERMEASURE RESULT DB
200 RISK ANALYSIS RESULT DISPLAY APPARATUS
300 RISK ANALYSIS RESULT DISPLAY APPARATUS
400 RISK ANALYSIS RESULT DISPLAY APPARATUS
500 COMPUTER APPARATUS
510 CPU
520 MEMORY
530 ROM
540 RAM
550 COMMUNICATION IF
560 USER IF

What is claimed is:

1. A risk analysis result display apparatus comprising:
at least one memory storing instructions, and
at least one processor configured to execute the instructions to:
compare a risk analysis result obtained by assessing a risk to a system to be analyzed in a first assessment period with a risk analysis result obtained by assessing the risk to the system to be analyzed in a second assessment period different from the first assessment period, and extract a difference between the risk analysis result obtained in the first assessment period and the risk analysis result obtained in the second assessment period; and
display the extracted difference for a user.

2. The risk analysis result display apparatus according to claim 1, wherein
the risk analysis result includes a first risk analysis result obtained by assessing a risk that arises when an attack is made on the system to be analyzed along an attack path from an entry point included in the system to be analyzed to an attack target, the attack path including at least one attack step including an attack source, an attack destination, and an attack method, and
the at least one processor is further configured to execute the instructions to extract, as the difference, at least one attack step that is not present in the first risk analysis result in the first assessment period, but is present in the first risk analysis result in the second assessment period.

3. The risk analysis result display apparatus according to claim 2, wherein the at least one processor is further configured to execute the instructions to display, for the user, an attack step extracted as the difference in such a manner that an attack step that is present in both the first risk analysis result obtained in the first assessment period and the first risk analysis result obtained in the second assessment period and the attack step extracted as the difference can be distinguished from each other.

4. The risk analysis result display apparatus according to claim 2, wherein
the risk analysis result further includes a second risk analysis result obtained by assessing a risk that arises when an attack is made on an asset in the system to be analyzed by at least one conceivable attack method, and
the at least one processor is further configured to execute the instructions to:
classify attack steps extracted as the difference into a first type attack step of which a combination of an asset at the attack destination and the attack method is present in both the second risk analysis result obtained in the first assessment period and the second risk analysis result obtained in the second assessment period, and a second type attack step of which a combination of an asset at the attack destination and the attack method is not present in the second risk analysis result obtained in the first assessment period but is present in the second risk analysis result obtained in the second assessment period; and
display, for the user, the attack step extracted as the difference in such a manner that the first type attack step and the second type attack step can be distinguished from each other.

5. The risk analysis result display apparatus according to claim 4, wherein the at least one processor is further configured to execute the instructions to display, for the user, a vulnerability used in the attack method in the second type attack step while associating the vulnerability with the second type attack step.

6. The risk analysis result display apparatus according to claim 5, wherein the at least one processor is further configured to execute the instructions to display, for the user, information about the vulnerability.

7. The risk analysis result display apparatus according to claim 4, further comprising a countermeasure result database configured to store a security measure taken for an asset and an attack method based on the risk analysis result, wherein
the at least one processor is further configured to execute the instructions to display, for the user, a security measure taken for an attack destination of the first type attack step, and an asset and an attack method corresponding to the attack destination, acquired from the countermeasure result database.

8. The risk analysis result display apparatus according to claim 4, wherein the at least one processor is further configured to execute the instructions to graphically display the attack path on a screen of a display device, and displays, in the graphically-displayed attack path, an attack step that is present in both the first risk analysis result obtained in the first assessment period and the first risk analysis result obtained in the second assessment period, the first type attack step, and the second type attack step in display modes different from one another.

9. The risk analysis result display apparatus according to claim 4, wherein the at least one processor is further configured to execute the instructions to display a table showing the first risk analysis result on a display screen of a display device, and displays, in the displayed table showing the first risk analysis result, an attack step that is present in both the first risk analysis result obtained in the first assessment period and the first risk analysis result obtained in the second assessment period, the first type attack step, and the second type attack step in display modes different from one another.

10. The risk analysis result display apparatus according to claim 4, wherein
the first risk analysis result includes a risk assessment for each attack step, and
the at least one processor is further configured to execute the instructions to specify an attack step of which a risk assessment in the first risk analysis result obtained in the second assessment period changes from that in the first risk analysis result obtained in the first assessment period, and further extracts the specified attack step as the difference.

11. The risk analysis result display apparatus according to claim 10, wherein at least one processor is further configured to execute the instructions to graphically display the attack path on a screen of a display device, and displays, in the graphically-displayed attack path, an attack step that is present in both the first risk analysis result obtained in the first assessment period and the first risk analysis result obtained in the second assessment period, the first type attack step, the second type attack step, and the attack step of which the specified risk assessment changes in display modes different from one another.

12. The risk analysis result display apparatus according to claim 10, wherein at least one processor is further configured to execute the instructions to display a table showing the first risk analysis result on a display screen of a display device, and displays, in the displayed table showing the first risk analysis result, an attack step that is present in both the first risk analysis result obtained in the first assessment period and the first risk analysis result obtained in the second assessment period, the first type attack step, the second type attack step, and the attack step of which the specified risk assessment changes in display modes different from one another.

13. The risk analysis result display apparatus according to claim 4, wherein the at least one processor is further configured to execute the instructions to specify an asset and an attack method of which a risk assessment in the second risk analysis result obtained in the second assessment period changes from that in the second risk analysis result obtained in the first assessment period, and further extracts, as the difference, an attack step in which its attack destination and its attack method are the specified asset and the specified attack method.

14. The risk analysis result display apparatus according to claim 13, wherein the at least one processor is further configured to execute the instructions to graphically display the attack path on a screen of a display device, and displays, in the graphically-displayed attack path, an attack step that is present in both the first risk analysis result obtained in the first assessment period and the first risk analysis result obtained in the second assessment period, the first type attack step, the second type attack step, and the attack step in which its attack destination and its attack method are the specified asset and the specified attack method in display modes different from one another.

15. The risk analysis result display apparatus according to claim 14, wherein the at least one processor is further configured to execute the instructions to display a table showing the first risk analysis result on a display screen of a display device, and displays, in the displayed table showing the first risk analysis result, an attack step that is present in both the first risk analysis result obtained in the first assessment period and the first risk analysis result obtained in the second assessment period, the first type attack step, the second type attack step, and the attack step in which its attack destination and its attack method are the specified asset and the specified attack method in display modes different from one another.

16. The risk analysis result display apparatus according to claim 1, wherein the at least one processor is further configured to execute the instructions to extract, as the difference, an entity to be assessed of which a risk assessment in the risk analysis result obtained in the second assessment period changes from that in the risk analysis result obtained in the first assessment period.

17. The risk analysis result display apparatus according to claim 16, wherein
the risk analysis result is a risk analysis result obtained by assessing a risk that arises when an attack is made on the system to be analyzed along an attack path from an entry point included in the system to be analyzed to an attack target, the attack path including at least one attack step including an attack source, an attack destination, and an attack method,
the risk analysis result includes a risk assessment for each attack step, and
the at least one processor is further configured to execute the instructions to specify an attack step of which the risk assessment in the risk analysis result obtained in the second assessment period changes from that in the risk analysis result obtained in the first assessment period, and extracts the specified attack step as the difference.

18. The risk analysis result display apparatus according to claim 16, wherein
the risk analysis result is a risk analysis result obtained by assessing a risk that arises when an attack is made on an asset in the system to be analyzed by at least one conceivable attack method, and
the at least one processor is further configured to execute the instructions to specify an asset and an attack method of which the risk assessment in the risk analysis result obtained in the second assessment period changes from that in the risk analysis result obtained in the first assessment period, and extracts the specified asset and attack method as the difference.

19. The risk analysis result display apparatus according to claim 16, wherein the at least one processor is further configured to execute the instructions to extract, as the difference, an entity to be assessed of which a change of an assessment value of the risk assessment in the risk analysis result obtained in the second assessment period from that in the risk analysis result obtained in the first assessment period is larger than or equal to a predetermined change.

20. A risk analysis result display method comprising:
comparing a risk analysis result obtained by assessing a risk to a system to be analyzed in a first assessment period with a risk analysis result obtained by assessing the risk to the system to be analyzed in a second assessment period different from the first assessment period;
extracting a difference between the risk analysis result obtained in the first assessment period and the risk analysis result obtained in the second assessment period based on a result of the comparison; and
displaying the extracted difference for a user.

21. The risk analysis result display method according to claim 20, wherein
the risk analysis result includes a first risk analysis result obtained by assessing a risk that arises when an attack is made on the system to be analyzed along an attack path from an entry point included in the system to be analyzed to an attack target, the attack path including at least one attack step including an attack source, an attack destination, and an attack method, and
in the extraction of the difference, at least one attack step that is not present in the first risk analysis result in the first assessment period but is present in the first risk analysis result in the second assessment period is extracted as the difference.

22. The risk analysis result display method according to claim 21, wherein
the risk analysis result further includes a second risk analysis result obtained by assessing a risk that arises when an attack is made on an asset in the system to be analyzed by at least one conceivable attack method,
the risk analysis result display method further comprises classifying attack steps extracted as the difference into a first type attack step of which a combination of an asset at the attack destination and the attack method is present in both the second risk analysis result obtained in the first assessment period and the second risk analysis result obtained in the second assessment period, and a second type attack step of which a combination of an asset at the attack destination and the attack method is not present in the second risk analysis result obtained in the first assessment period but is present in the second risk analysis result obtained in the second assessment period, and
the displaying the difference for the user comprises displaying, for the user, the attack step extracted as the difference in such a manner that the first type attack step and the second type attack step can be distinguished from each other.

23. A non-transitory computer readable medium storing a program for causing a computer to perform a process of:
comparing a risk analysis result obtained by assessing a risk to a system to be analyzed in a first assessment period with a risk analysis result obtained by assessing the risk to the system to be analyzed in a second assessment period different from the first assessment period;
extracting a difference between the risk analysis result obtained in the first assessment period and the risk analysis result obtained in the second assessment period based on a result of the comparison; and
displaying the extracted difference for a user.
